(19) United States
(12) Patent Application Publication
(10) Pub. No.: US 2021/0032123 A1
(43) Pub. Date: Feb. 4, 2021

(54) Cleaning Device for Ponds

(71) Applicant: OASE GmbH, Hörstel-Riesenbeck (DE)

(72) Inventor: Andreas Hanke, Osnabruck (DE)

(21) Appl. No.: 17/023,467

(22) Filed: Sep. 17, 2020

Related U.S. Application Data
(63) Continuation of application No. 15/789,159, filed on Oct. 20, 2017.

(30) Foreign Application Priority Data
Oct. 25, 2016 (DE) 10 2016 120 351.3

(51) Int. Cl. C02F 1/00; E04H 4/16; A01K 63/10; E02F 5/28; A01K 63/04; B01F 13/02; B01F 15/00; C02F 3/12; C02F 3/26; C02F 7/00

(52) U.S. Cl. CPC C02F 1/004; E04H 4/1663; A01K 63/10; E02F 5/287; A01K 63/042; B01F 2003/04865; B01F 15/005; C02F 3/1294; C02F 3/26; C02F 7/00; B01F 13/0205

(57) ABSTRACT

A cleaning device for ponds (1) for interaction with at least one pond filter for removal of solids (2) from the pond (1) has a sediment swirling device (3) with a pump (11) which sucks in a swirling medium and discharges the latter through at least one ejector channel (4, 5) in the area of sedimented solids (2). The cleaning device is self-floating and is provided with a motion drive (14) and a location determination device for the purpose of directional control.

### CROSS-REFERENCE TO RELATED APPLICATIONS

This application is a continuation application of U.S. application for patent Ser. No. 15/789,159 having a filing date of 20 Oct. 2017 and claiming a priority date of 25 Oct. 2016 based on prior filed German patent application No. 10 2016 120 351.3, the entire contents of the aforesaid United States application for patent and the aforesaid German patent application being incorporated herein by reference.

### BACKGROUND OF THE INVENTION

Ponds, in particular when they are designed as standing bodies of water, should be regularly cleaned in order to limit turbidity, sedimentation, and algae growth. For pond cleaning in practice, pond filters for filtering out suspended particles, surface vacuum cleaners—so-called skimmers—for vacuuming and filtering floating contaminants, such as leaves, and in addition mud vacuum cleaners are named with which sediments that have deposited as mud on the pond bottom can be vacuumed and removed in intervals.

While cleaning by means of filters and skimmers is realized substantially automatically, mud vacuum cleaners in general are used as needed in intervals, namely pump motor driven but guided by hand.

The invention has the object to simplify pond cleaning.

### SUMMARY OF THE INVENTION

This object is solved according to the invention by a cleaning device for ponds for interaction with at least one pond filter for removal of solids from the pond, characterized by a sediment swirling device with a pump that sucks in a swirling medium and ejects the latter through at least one ejector channel in the area of the sedimented solids.

Through the use of a sediment swirling device in the proposed cleaning device, by means of a sucked-in swirling medium—preferably water from the pond itself but also, for example, air—and delivery of the swirling medium through an ejector channel or outlet in the area of the sedimented solids, i.e., generally at the pond bottom, the sediments are swirled up so that they move into the active area of the filter and can be filtered out by it. In this way, the efficiency of the pond filter is increased and the interval between necessary employments of a mud vacuum cleaner can be increased

Advantageously, an air intake can be connected with the ejector channel of the sediment swirling device. When water is sucked in as a swirling medium, no additional drive for the air intake action is required because the latter can be ensured by means of the ejector principle. The sucked-in water provides, in connection with the additionally sucked-in air, an improved sediment swirling action and oxygen enrichment in the body of water.

The sediment swirling device can preferably comprise at least one floating body by means of which it can float on its own on the water surface. Depending on the size of the pond, it can also be expedient when the sediment swirling device is movably supported in order to be able to work on different pond areas. For this purpose, the sediment swirling device can comprise a motion drive and optionally a direction guide, when it is to be moved in a targeted fashion in certain directions of the pond. Should the sediment swirling device have a substantially round outer circumference, it is expedient that it is provided with at least one keel or daggerboard so that it does not rotate exclusively about an own axis.

The motion drive can be realized in a simple way in that one or the injector channel is not embodied to point vertically downward but to be angled (with a horizontal direction component) so that it acts as jet propulsion drive due to the swirling medium that is ejected thereat. When the movement direction of the sediment swirling device is to be influenced in a targeted fashion, it is advantageous in this context when the angled ejector channel is motorically adjustable in such a way that the direction in which the swirling medium is discharged can be changed in relation to the attachment at the sediment swirling device.

A particularly advantageous embodiment comprises at least two ejector channels of different length or different ranges in the pond. In particular, a longer ejector channel can penetrate into deeper regions of the pond in this way while a shorter ejector channel swirls up sediments in the shallower areas, usually rim areas, of the pond.

The pump of the sediment swirling device is preferably driven electromotively for which purpose an energy supply is provided. It is possible to provide this energy supply by means of a cable wherein the sediment swirling device by means of this cable can be at the same time anchored at the bottom whereby also its radius of action is fixed. Since for such a fixation of the sediment swirling device however no filament-like foreign bodies may be present in the pond, for example, no water lilies, a rechargeable battery pack is to be preferred as energy supply for many purposes of use. The latter makes it possible that the sediment swirling device can move freely in the pond without possibly catching on an anchor, cable or the like.

Preferably, it is provided that the sediment swirling device comprises a sender receiver unit for wireless communication means with a control unit. This can be, for example, radio, BLUETOOTH®, ZIGBEE®, wireless LAN, sound waves or infrared. In particular, a radio remote control and an additional time control unit are preferably used here so that the cleaning device with the sediment swirling device works substantially automatically as a pond robot. By means of the time control unit, it can be adjusted, for example, that the sediment swirling device operates only at night. In this way, suspended substances that have not been filtered out can deposit again after completion of the swirling action so that the water is clear during the day.

The sediment swirling device preferably can also comprise location determination means, for example, GPS or other positioning standards, so that the actual position of the sediment swirling device can always be monitored. In combination with the afore described motion drive, these location determination means together with an evaluation unit for position information can be connected to a navigation system so that the sediment swirling device cannot only move by random control on the pond but can be moved in a targeted fashion to certain positions.

It is also advantageous to provide a charging station that is connectable permanently or in particular only temporarily with the sediment swirling device so that a rechargeable battery pack that is disposed in the sediment swirling device can be regularly recharged. In particular in interaction with the wireless communication means and the evaluation unit for position information as well as the motion drive, the charging station can be approached actively and in a targeted fashion when the sediment swirling device is not operating and/or the rechargeable battery pack requires recharging.

The cleaning device according to the invention can be utilized with the preferably provided features as a fully automated pond robot whereby the filtering performance of the pond filter can be significantly increased and the intervals of mud vacuuming for sediment removal can be significantly extended so that the personnel expenditure for pond care can be greatly reduced as a whole.

### BRIEF DESCRIPTION OF THE DRAWINGS

Further advantages and details result from the claims as well as from an embodiment of the invention illustrated in the drawings which will be explained in the following.

FIG. 1 shows schematically the cleaning device according to the invention in use.

FIG. 2 shows an enlarged illustration of the cleaning device of FIG. 1.

FIG. 2a shows the cleaning device with a telescoping length-variable ejector channel.

FIG. 3 shows a vertical section of the article of FIG. 2.

### DESCRIPTION OF THE PREFERRED EMBODIMENTS

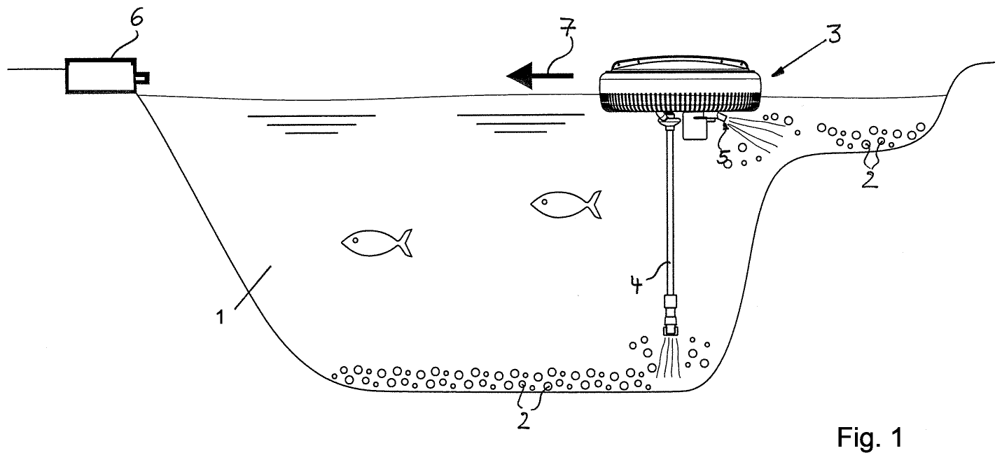

In the situation illustrated in FIG. 1, a pond 1 is illustrated where sediments 2 have deposited at the bottom areas. A sediment swirling device 3 for ponds is floating on the water surface. The illustration is only schematic and is not true to scale. Normally, the pond 1 in relation to the sediment swirling device 3 will be significantly larger than illustrated here. The sediment swirling device 3 sucks in a swirling medium—here a pond water/air mixture—and discharges the latter again through ejector channels 4, 5 in the area of the sedimented solids 2, also referred to as mulm. For the basic function of the sediment swirling device 3, one ejector channel 4 or 5 is sufficient. The embodiment illustrated here however is provided with an ejector channel 4, which penetrates by a preferably partially flexible tube or e.g. a hose into deeper areas of the pond, while the ejector channel 5 is oriented such that it swirls up sediments 2 in shallower areas and rim areas of the pond. The solids 2 which are swirled up by the swirling medium can then be filtered out from the pond water by a filter, not illustrated here.

The sediment swirling device illustrated in FIG. 1 is an embodiment which is not provided with a cable. It comprises rechargeable power packs which can be recharged as needed at a charging station 6 preferably in the pond rim area. Arrow 7 indicates the movement direction of the sediment swirling device 3 toward the charging station which can be initiated by the ejection direction of the second ejector channel 5. The charging station 6 is preferably also at least partially movably supported, for example, floatingly, in order to adjust to the water level.

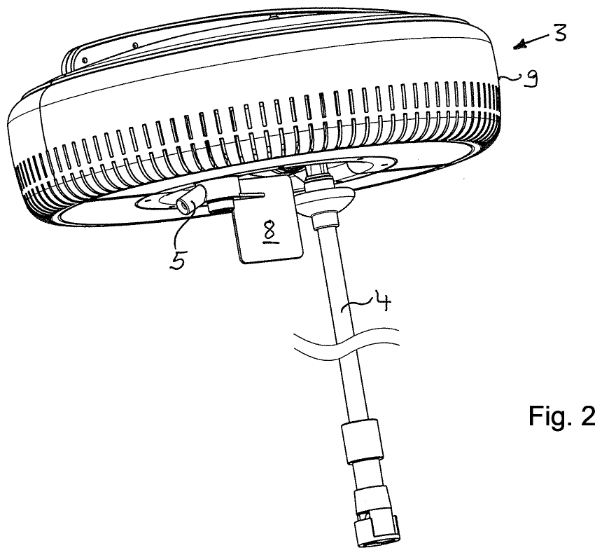

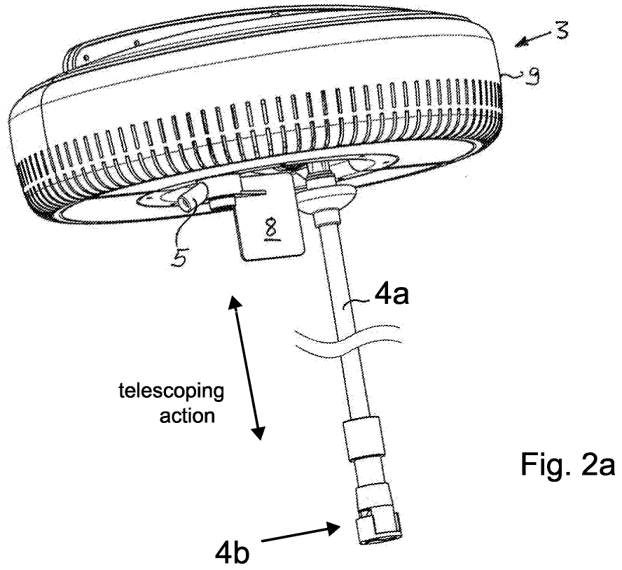

FIG. 2 shows the sediment swirling device 3 in perspective illustration in a view slightly from below. Here, it can be in particular seen that the second ejector channel 5 is connected at the opposite end with a rudder 8. Because of this and due to the slightly slanted angled arrangement of the ejector channel 5, the latter is acting as a jet propulsion drive with the rudder 8 as a direction guide so that even a sediment swirling device 3 embodied, as herein, with a round outer circumference does not move forward with random rotation but with directed movement. This could be achieved alternatively also by a fin or a daggerboard arranged at the bottom side of the sediment swirling device 3.

The ejector channel 4 is illustrated in FIG. 2 interrupted in regard to its length and is significantly longer in practice than illustrated here. In particular, it is possible to embody the ejector channel 4a in a telescoping length-variable way (see FIG. 2a). When the lower end 4b of the telescoping length-variable ejector channel 4a is balanced with respect to its weight such that it is spaced apart from the bottom of the pond by the ejection pressure of the swirling medium, a constant working height for optimal sediment swirling action can be achieved in this way. The lower end 4b of the ejector channel 4a functions thus as a dabbling nozzle.

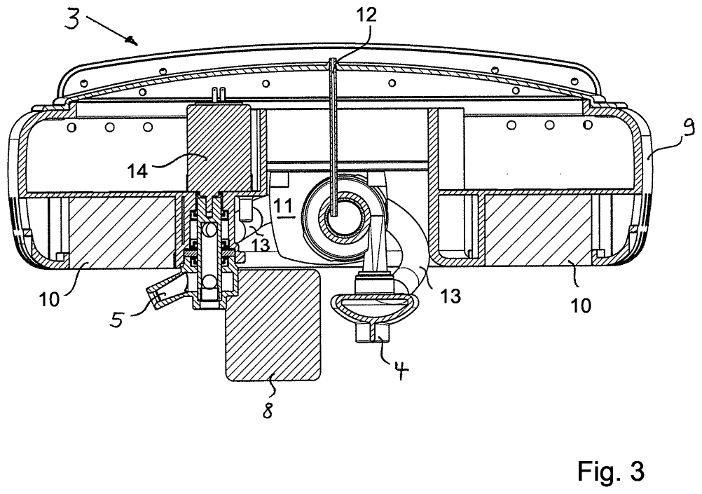

The details of the sediment swirling device 3 for ponds can be seen in particular in the section illustration of FIG. 3. Here, it can be seen that the sediment swirling device 3 within its housing 9 is provided with floating bodies 10 that hold the device 3 at the water surface. In the interior of the device 3, a pump 11 is provided which sucks in pond water and discharges it again through the two ejector channels 4, 5. By means of a Venturi effect, air is admixed to this pond water by means of an air intake 12 which increases the action of the thus formed swirling medium and also aerates the pond at the same time. The swirling medium is then discharged again through the ejector channels 4 and 5 wherein in the illustration according to FIG. 3 the long lower area of the ejector channel 4 is not illustrated. Both ejector channels 4, 5 are connected to each other by a connecting line 13 so that both of them can also be supplied by the same pump 11. This is however not mandatory.

The ejector channel 5 serves at the same time as a jet propulsion drive and is arranged for this purpose at a slant at an angle between 10° and 50°, preferably approximately 30°, relative to the horizontal and, as illustrated, is rotatably supported. Its direction can be actively controlled by a motion drive 14 with motor. The rudder 8 is also functioning as a directional drive in this context.

In the upper area of the sediment swirling device 3, a rechargeable battery pack—here not illustrated separately in the section illustration—for energy supply of energy consumers such as the pump and the motion drive can be accommodated as well as optionally an electronic control device for active control of pump 11 and in particular motion drive 14. By means of control of the motion drive 14, the surface of the pond can be traveled across in a targeted fashion or it is possible to have the sediment swirling device 3 move purely by random control in a chaotic system.

In such a completely automated operation of the cleaning device, the sediment swirling device 3 works as a pond robot. Even for non-automated utilization, the sediment swirling device 3 in cold weather provides due to its movement the additional function of keeping the pond surface free of ice.

What is claimed is:

1. A method for cleaning a pond, the method comprising:
positioning a telescoping length-variable ejector channel of a sediment swirling device near a bottom of the pond;
ejecting a swirling medium at an ejection pressure toward the bottom of the pond through a lower end of the telescoping length-variable ejector channel to swirl up sediments from the bottom of the pond, wherein the lower end is balanced with respect to a weight thereof relative to the ejection pressure;
spacing apart the lower end from the bottom of the pond by the ejection pressure to follow a contour of the bottom of the pond and to keep a constant working height of the lower end relative to the bottom of the pond.

2. The method according to claim 1, further comprising floating the sediment swirling device on a surface of the pond.

3. The method according to claim 1, further comprising sucking in air as the swirling medium.

4. The method according to claim 1, further comprising moving the sediment swirling device by a motion drive across the pond.

5. The method according to claim 1, further comprising moving the sediment swirling device across the pond by an angled ejector channel acting as a jet propulsion drive.

6. The method according to claim 5, further comprising motorically adjusting the angled ejector channel for direction setting of a movement of the sediment swirling device across the pond.

7. The method according to claim 1, further comprising supplying an electromotively driven pump of the sediment swirling device ejecting the swirling medium with energy from a rechargeable battery pack.

8. The method according to claim 1, further comprising the sediment swirling device, equipped with a sender-receiver, communicating wireless with a control unit.

9. The method according to claim 1, further comprising determining a location of the sediment swirling device by providing a location determination means on the sediment swirling device.

10. The method according to claim 1, further comprising providing the sediment swirling device with an evaluation unit for position information and connecting the evaluation unit to a motion drive of the sediment swirling device to form a navigation system.

11. The method according to claim 1, further comprising providing a charging station and connecting the sediment swirling device to the charging station to recharge a rechargeable battery pack of sediment swirling device.
